(19) United States
(12) Patent Application Publication
(10) Pub. No.: US 2018/0255614 A1
(43) Pub. Date: Sep. 6, 2018

(54) PROGRAMMABLE LED DRIVER

(71) Applicant: KELSEY-HAYES COMPANY, Livonia, MI (US)

(72) Inventor: Jeffrey A. Sewell, Wyandotte, MI (US)

(21) Appl. No.: 15/759,862

(22) PCT Filed: Sep. 27, 2016
(86) PCT No.: PCT/US16/53874

§ 371 Date: Mar. 14, 2018

Related U.S. Application Data
(60) Provisional application No. 62/233,659, filed on Sep. 28, 2015.

(51) Int. Cl. H05B 33/08

(52) U.S. Cl. CPC H05B 33/0815; B60Q 3/80; H05B 33/089

(57) ABSTRACT

A closed-loop LED drive circuit includes at least one LED, a voltage source, and a voltage regulator connected to the voltage source to provide a regulated voltage output. A one-time-programmable voltage source is connected to an output of the voltage regulator and a current controlled drive circuit is connected to the one-time-programmable voltage source for providing a drive current to the at least one LED in response to an output from the one-time-programmable voltage source. An end of line tester monitors the light intensity of the LED device and provides a signal indicative thereof to said one-time-programmable voltage source. The one-time-programmable voltage source stores the light intensity value and uses the light intensity value to control its output voltage to the current control drive circuit.

### RELATED APPLICATIONS

This application claims priority from U.S. Patent Application Ser. No. 62/233,659, filed 28 Sep. 2015, which is incorporated herein in its entirety

### FIELD OF THE INVENTION

The present invention is directed to a programmable light emitting diode (“LED”) driver using a closed loop illumination tuning to establish illumination intensity requirements.

### BACKGROUND

LED devices provide illumination for many applications including vehicle devices such as illuminated switches, control stalks, electronic control panels, etc. LED drive circuits for illuminating LED devices are known. To control the illumination of an LED device, one known technique uses matched resistors and LED intensity bins to control the current through the device which, in turn, controls the illumination intensity. The intensity of an LED device is a function not only of the selected drive control resistors and drive voltage source, but also a function of the plastic housing thickness, the amount of any paint applied to the LED device, etching process, tolerance of resistors used in the LED drive circuit to control the drive current, and the tolerance of the supply voltage. The intensity control has been controlled in an open-loop process. Since each component in the illumination electrical and mechanical circuit has its own unique variations, this is a labor intensive process.

### SUMMARY OF THE INVENTION

The present invention provides an LED drive control using a closed loop control arrangement using a programmable LED driver. The programmed drive circuit is placed into a final assembly with its associated LED. An end of line tester that includes a camera measures intensity of the LED device and controls a one-time-programmable current driver. Each LED device has its own associated current driver that is programmed for the desired intensity so that no further controller is needed to control the LED device output intensity. The one-time-programmable current driver includes a non-volatile memory for storing a drive control value for its associated LED device even after power is removed. Once repowered, the LED will provide the desired light intensity through its programmed drive circuit.

In accordance with one example embodiment of the present invention, a current controlled LED drive circuit includes at least one LED, a voltage source, and a voltage regulator connected to the voltage source to provide a regulated voltage output. A one-time-programmable voltage source is connected to an output of the voltage regulator and a current controlled drive circuit is connected to the one-time-programmable voltage source for providing a drive current to at least one LED in response to an output from the one-time-programmable voltage source. An end of line tester monitors the light intensity of the LED device and provides a signal indicative thereof to said one-time-programmable voltage source. The one-time-programmable voltage source stores the light intensity value and uses the light intensity value to control its output voltage to the current control drive circuit.

In accordance with another aspect of the present invention, a method is provided for calibrating a closed-loop light emitting diode (LED) drive circuit. A current associated with the closed-loop LED drive circuit is set to a determined value. A light intensity of an LED associated with the closed-loop LED drive circuit is measured. The closed-loop LED drive circuit is programmed to the determined value if the measured light intensity is within a target range. A target current is calculated from the determined value and the measured light intensity if the measured light intensity is not within the target range.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic block diagram of a closed loop programmable LED drive circuit arrangement in accordance with one example embodiment of the present invention;

FIG. 2 is a schematic block diagram of a single closed loop programmable LED drive circuit arrangement of FIG. 1 in further detail; and

FIG. 3 is a method for calibrating a closed loop programmable LED drive circuit in accordance with an implementation of the present invention.

### DETAILED DESCRIPTION

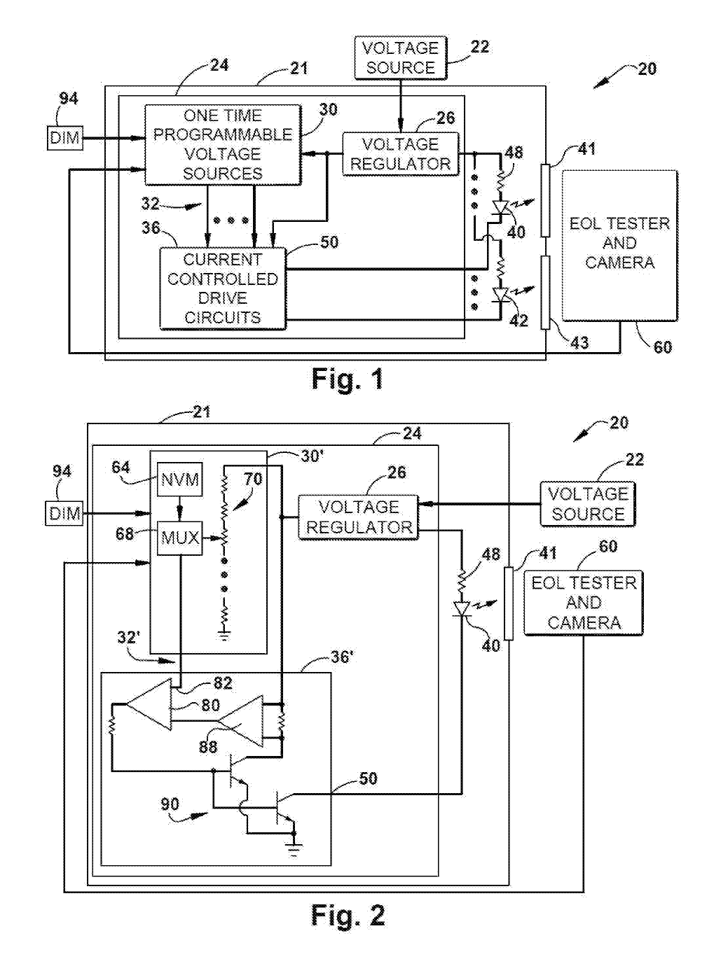

Referring to FIG. 1, a closed loop programmable LED drive circuit 20 in accordance with an example embodiment of the present invention is shown for establishing illumination intensity requirements of an LED device 21. The closed loop drive circuit 20 includes a voltage source 22 connected to a programmable drive circuit 24 for supplying electrical current. Specifically, a voltage regulator 26 of the drive circuit 24 is connected to the voltage source and outputs at least one controlled, filtered, and variable voltage value.

The programmable drive circuit 24 further includes a plurality of one-time-programmable voltage sources 30 connected to one output of the voltage regulator 26. Each one of the one-time-programmable voltage sources 30 provides an associated programmable drive output voltage 32. The outputs 32 of the one-time-programmable voltage sources 30 are connected to associated current controlled drive circuits 36 that provided a controlled current sink value responsive to its associated voltage source 32.

The programmable drive circuit 24 is connected to a plurality of LEDs 40, 42 of the LED device 21. Although two LEDs are shown, those skilled in the art should appreciate that any number of LEDs could be driven by the programmable drive circuit 24. The connection to one LED device is explained for simplicity, it being understood that all other LED devices are similarly connected and powered. The LED may be part of a vehicle control device such as an illuminated switch, a control stalk, an electronic control panel, etc. The LED device 21 includes a symbol shaped window and/or light pipe 41, 43 associated with the LEDs 40, 42, respectively. The light from the LEDs is visible through their associated symbol shaped window and/or light pipe.

The anode of the LED device 40 is connected to one output of the voltage regulator 26 through an associated current limit resistor 48. The cathode of the LED device 40 is connected to one current sink drive input 50 of the current controlled drive circuit 36.

FIG. 2 shows the details of a single drive circuit of the programmable drive circuit 24. Referring to FIGS. 1 and 2, the programmable drive circuit 24 is connected to an end-of-line (“EOL”) tester 60 that includes a camera. The camera of the EOL tester 60 monitors the light intensity of each LED 40, 42 the LED device 21 as viewed through the associated symbol shaped windows and/or light pipe 41, 43 of the LEDs and—provides an electrical signal to the one-time-programmable voltage sources 30 setting a desired current or light intensity through the LED device 27. The value from the EOL tester 60 is used to set a resistor value to an internal non-volatile memory (“NVM”) 64. The NVM 64 controls an internal multiplexer (“MUX”) 68.

The one-time-programmable voltage source includes a resistor divider network 70 connected to the output of the voltage regulator 26 and electrical ground. The MUX 68 selects the location in the resistor divider network 70 in response to the calculated target current or light intensity indication from the EOL tester 60. The output of the MUX 68 is then a controlled voltage value calculated by the EOL tester in response to the monitored light intensity output from the EOL 60 through the electrical and mechanical illumination circuit. Since the value is stored in the NVM 64, once programmed, the EOL can be removed and the output voltage from the MUX 68 will remain a constant value. It should be appreciated that each LED 40, 42 will have its own target LED 40, 42 current or LED device 21 light intensity in the NVM 64 so the light intensity of each LED 40, 42 can be controlled without further monitoring or control process.

The output of each MUX 68 is connected to an associated current controlled drive circuit 36. Referring to FIG. 2, the output of the MUX 68 of the one-time-programmable voltage source 30′ associated with LED 40 is connected to its associated current controlled drive circuit 36′. The current controlled drive circuit 36′ includes a comparator 80 having one input 82 connected to the output of its associated MUX 68. The remainder of the current controlled drive circuit 36′ includes an op-amp 88 and drive transistors 90 connected so as to provide a pulse-width-modulated (“PWM”) drive signal at the output 50 that controls the current through the LED 40, which, in turn, controls its output light intensity.

It should therefore be appreciated that the present arrangement provides an initial closed-loop control to establish the light intensity current control value for each LED 40, 42 and balance through the LED device 21. Once the intensity values are set and stored in the NVM for each associated LED, the monitoring circuitry can be disconnected and the intensity control is maintained.

A dimming control function (“DIM”) 94 is provided and is connected to the one-time-programmable voltage sources 30 to control the light intensity changes of all LED's of the system. During initial calibration of the system, the DIM would typically be set to a nominal intensity value and all the LED drive circuits programmed to the desired nominal intensity level so as to provide a desired LED intensity.

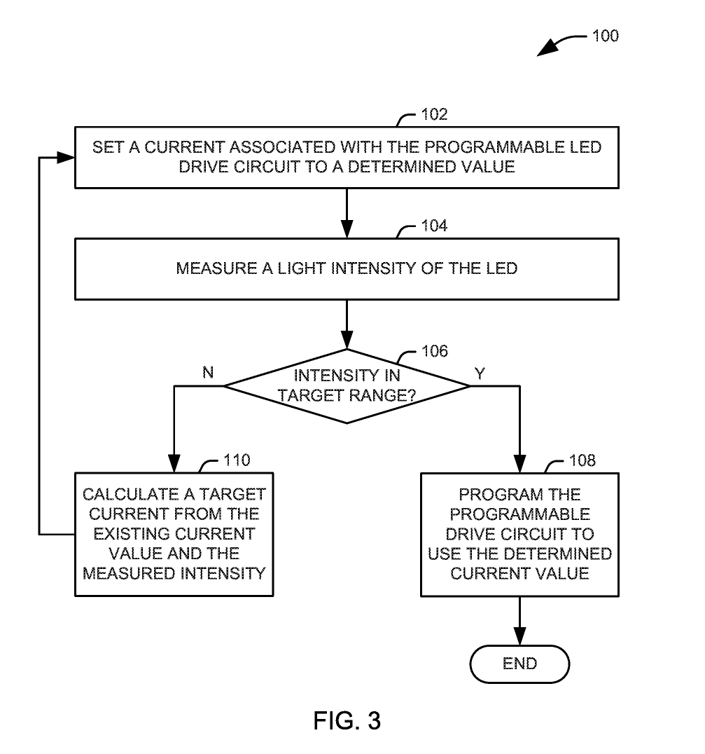

FIG. 3 illustrates a method 100 for calibrating a closed loop programmable LED drive circuit in accordance with an implementation of the present invention. At 102, a current associated with the programmable LED drive circuit is set to a determined value. Specifically, a voltage source associated with the LED drive circuit can be instructed to provide an appropriate output to an associated current controlled drive circuit for a given LED. At the beginning of the process, the determined value is a default value selected for the system. At 104, a light intensity of the LED device is measured, for example, at a camera associated with an end-of-line test system.

At 106, it is determined if the measured light intensity is within a targeted range of light intensity. If so (Y), further calibration is unnecessary, and the programmable drive circuit is programmed to use the existing current value at 108. For example, a non-volatile memory within the programmable drive circuit can be latched to a voltage selected to produce the determined value such that the determined value is maintained after the end-of-line test system is removed. The method then terminates.

If the measured light intensity is not within the targeted range (N), a target current is calculated from the existing current value and the measured intensity at 110. In one example, the target current is a linear combination of the existing current value and a difference between the measured light intensity and a target light intensity, for example, a value at the center of the targeted range. It will be appreciated, however, that a non-linear combination of these could be used, depending on the specific implementation. The method then returns to 102 to set the current associated with the programmable LED drive circuit to the target current value.

From the above description of the invention, those skilled in the art will perceive improvements, changes, and modifications. Such improvements, changes, and modifications within the skill of the art are intended to be covered by the appended claims.

Having described the invention, the following is claimed:

1. A closed-loop light emitting diode (LED) drive circuit comprising:
at least one LED;
a voltage source;
a voltage regulator connected to the voltage source to provide a regulated voltage output;
a one-time-programmable voltage source connected to an output of the voltage regulator;
a current controlled drive circuit connected to the one-time-programmable voltage source for providing a drive current to the at least one LED in response to an output from the one-time-programmable voltage source; and
an end of line tester for monitoring the light intensity of the LED device and a signal indicative thereof to said one-time-programmable voltage source, said one-time-programmable voltage source storing said light intensity value and using said light intensity value to control its output voltage to said current control drive circuit.

2. The closed-loop LED drive circuit of claim 1 wherein said at least one LED is mounted in a vehicle device such as an illuminated switch, a control stalk, and an electronic control panel.

3. The closed-loop LED drive circuit of claim 2 wherein said vehicle device includes a symbol window and/or light pipe for passing light from said LED to said end of line tester.

4. The closed-loop LED drive circuit of claim 1, wherein the current controlled drive circuit comprises an operational amplifier and drive transistors connected so as to provide the drive current as a pulse-width-modulated drive signal.

5. The closed-loop LED drive circuit of claim 1, wherein the one-time-programmable voltage source comprises:
a non-volatile memory; and
a multiplexer controlled by the non-volatile memory.

6. The closed-loop LED drive circuit of claim 5, wherein the one-time-programmable voltage source further comprises at least one resistor divider network connected to the output of the voltage regulator and electrical ground, the multiplexer selecting a location in the at least one resistor divider network according to a resistor value stored in the non-volatile memory.

7. The closed-loop LED drive circuit of claim 6, wherein the current controlled drive circuit comprises:
an operational amplifier; and
a comparator having one input connected to an output of the multiplexer and one input connected to an output of the operational amplifier.

8. The closed-loop LED drive circuit of claim 1, wherein the at least one LED comprises a plurality of LEDs, the one-time-programmable voltage source comprises a one-time-programmable voltage source for each of the plurality of LEDs, and the current controlled drive circuit comprises a current controlled drive circuit for each of the plurality of LEDs.

9. The closed-loop LED drive circuit of claim 8, further comprising a dimming control function connected to the plurality of one-time-programmable voltage sources to control light intensity changes of the plurality of LEDs.

10. The closed-loop LED drive circuit of claim 8, wherein a first one-time-programmable voltage source of the plurality of one-time-programmable voltage sources stores a first light intensity value and a second one-time-programmable voltage source of the plurality of one-time-programmable voltage sources stores a second light intensity value.

11. A method for calibrating a closed-loop light emitting diode (LED) drive circuit comprising:
setting a current associated with the closed-loop LED drive circuit to a determined value;
measuring a light intensity of an LED associated with the closed-loop LED drive circuit;
programming the closed-loop LED drive circuit to the determined value if the measured light intensity is within a target range; and
calculating a target current from the determined value and the measured light intensity if the measured light intensity is not within the target range.

12. The method of claim 11, wherein if the measured light intensity is not within the target range, the method further comprises iteratively repeating the following steps until the measured light intensity is within the target range:
setting the current associated with the closed-loop LED drive circuit to the target current;
measuring the light intensity of the LED associated with the closed-loop LED drive circuit;
programming the closed-loop LED drive circuit to the target current if the measured light intensity is within a target range; and
calculating a new target current from the determined value and the measured light intensity if the measured light intensity is not within the target range.

13. The method of claim 11, wherein calculating the target current from the determined value and the measured light intensity comprises calculating the target current as a linear combination of the existing current value and a difference between the measured light intensity and a target light intensity.

14. The method of claim 11, wherein programming the closed-loop LED drive circuit to the determined value comprises latching a non-volatile memory within the closed-loop LED drive circuit to a voltage selected to provide the determined value.

15. The method of claim 11, wherein measuring the light intensity of the LED associated with the closed-loop LED drive circuit comprises monitoring the light intensity of the LED device at a camera associated with an end-of-line testing system.
